(19) United States
(12) Patent Application Publication
(10) Pub. No.: US 2003/0002964 A1
(43) Pub. Date: Jan. 2, 2003

(54) Handler system incorporating a semi-automatic tray replacement apparatus and method of use

(76) Inventors: Wee Boon Hee, Singapore (SG); Edmund Giam Chee Wei, Singapore (SG); Tan Seok Hiong, Singapore (SG)

Correspondence Address: Joseph A. Sawyer Jr., SAWYER LAW GROUP LLP, P.O. Box 51418, Palo Alto, CA, 94303, US

(21) Appl. No.: 09/894,733

(22) Filed: Jun. 27, 2001

(51) Int. Cl. B65G 1/00

(52) U.S. Cl. 414/331.18

(57) ABSTRACT

A system and method for automatically replacing a tray in a handler system is disclosed. The system and method includes a stacker assembly for housing a plurality of trays, each tray holding at least one device, and a replacement apparatus for automatically replacing a tray in the stacker assembly with a replacement tray. The system and method further includes identifying a tray in need of replacement, adjusting the stacker assembly so that the tray in need of replacement is aligned with the tray replacement apparatus, and replacing the tray with the replacement tray.

### FIELD OF THE INVENTION

The present invention relates generally to handler systems, and more particularly to a handler system which incorporates a semi-automatic tray replacement apparatus.

### BACKGROUND OF THE INVENTION

With advances in technology, manufacturing and testing functions have become highly automated processes, requiring little human supervision or intervention. In the testing environment, systems have been developed that can automatically select a device to be tested, pass it though any type of pretest preparation, test the device, gather and store the test results, and then pass the device to a holding area for further processing. In the past, some, if not all, of these steps were performed by an operator. Today, however, the entire process can function largely without human intervention.

After a device has been tested, it must be handled or stored in some manner so that the operator can differentiate between devices by type or testing results. In the area of integrated circuit testing, the devices are placed in trays after testing. Typically, the trays are organized to store particular types of devices. For example, one tray might be dedicated to a specific sort or bin category of a device. A handler system is an automated system that receives the tested device and places it in the appropriate tray according to its sort/bin category.

FIG. 1 illustrates a typical handler system 10, such as a Seiko Epson NS-5000, that operates in conjunction with a testing system (not shown). As is shown, the handler system 10, includes a stacker assembly 15 containing a plurality of slots 20a-20h for receiving an equal number of trays 30a-30h. The slots 20a-20h are arranged vertically, one on top of the other, such that the trays 30a-30h are stacked. Each tray 30a-30h accommodates several devices 40 and is dedicated to a particular sort/bin category. In operation, the testing system (not shown) indicates which sort/bin category tray 30a-30h is needed. A servomotor 50 in the handler system 10 moves the stacker assembly 15 vertically (Y-Axis movement) so that the slot 20e containing the appropriate tray 30e is aligned to a stationary output platform 60. The tray 30e is then placed on the output platform 60, where a pickup head 70 places the tested device 40 in the tray 30e. The tray 30e is then returned to its corresponding slot 20e, and the handler system 10 is ready to load another device 40.

When any tray 30a-30h is fully loaded with devices 40, the servomotor 50 moves the stacker assembly 15 to a home position. Once there, the handler system 10 stops operation and sounds an alarm, informing the operator that a particular tray, e.g., tray 30e is full and needs to be replaced. In response to the alarm, the operator must manually remove the fully loaded tray 30e, and replace it with an empty tray 30e' in the corresponding slot 20e. Thereafter, the operator must reset the handler system 10 to resume operation.

Once the alarm is sounded, the handler system 10 will cease operation, and will not restart until the full tray 30e has been replaced by the operator. In turn, the entire testing process upstream from the handler system 10 must stop because there is no where to place the devices 40 after they have been tested. If the operator is not present, the entire testing system will sit idle until the operator returns. Even if the operator is present to respond immediately to the alarm, it typically takes at least 30 seconds to exchange the tray 30e and to resume operation.

Thus, under the absolute best circumstances, testing will stop for approximately 30 seconds. Nevertheless, under the worst circumstances, down time can extend for hours. In any event, any down time adversely effects efficiency and productivity, the two qualities supposedly optimized by automated systems.

Accordingly, what is needed is a system and method for tray-replacement in an automated handler system, which minimizes workflow interruptions, and reduces the testing system down time. The system and method should provide for fast, efficient tray loading and unloading, and tray-exchange in an automated handler system. Further, the system and method should be cost effective and easy to implement with existing processes and equipment. The present invention addresses such a need.

### SUMMARY OF THE INVENTION

A system and method for automatically replacing a tray in a handler system is disclosed. The system and method includes a stacker assembly for housing a plurality of trays, each tray holding at least one device, and a replacement apparatus for automatically replacing a tray in the stacker assembly with a replacement tray. The system and method further includes identifying a tray in need of replacement, adjusting the stacker assembly so that the tray in need of replacement is aligned with the tray replacement apparatus, and replacing the tray with the replacement tray.

The system and method in accordance with the present invention overcomes the problems of conventional handler systems by providing the capability of replacing a tray without necessarily stopping the operation of the handler system. Hence, the time and cost incurred due to work stoppages is avoided. Additionally, the tray replacement apparatus allows the tray-exchange procedure to occur automatically and allows the handler system to resume operation without the immediate attention of the operator, thereby enhancing productivity. The system and method in accordance with the present invention increases overall operating speed, improves efficiency, and reduces the cost of manufacturing.

### BRIEF DESCRIPTION OF THE DRAWINGS

FIG. 1 illustrates a side view of a conventional handler system.

FIG. 2 illustrates a side view of the handler system incorporating the tray replacement apparatus in accordance with the present invention.

FIG. 3 illustrates a back view of the tray replacement apparatus in accordance with the present invention.

FIG. 4 illustrates the activated and deactivated states of a cylinder mounted on the housing bracket in accordance with one embodiment of the present invention.

FIG. 5 is a flow chart illustrating the process of replacing the tray in accordance with the present invention.

FIGS. 6A-6C illustrates the tray exchange in accordance with the present invention.

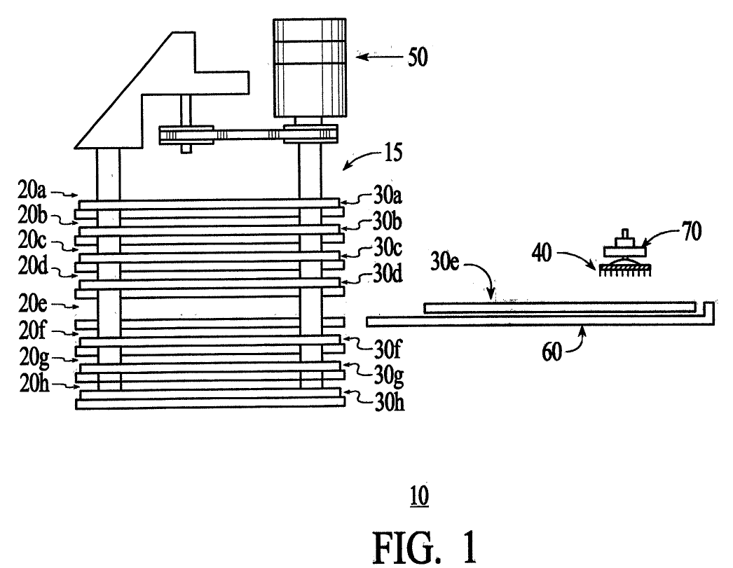

### DETAILED DESCRIPTION

The present invention relates generally to handler systems, and more particularly to a handler system for integrated devices incorporating a tray replacement apparatus. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The handler system in accordance with the present invention incorporates a tray replacement apparatus, which automatically unloads a tray from the stacker assembly to an unload area, and automatically reloads a replacement tray into the same slot. Once the replacement tray is in place, the handler system can resume its normal operation. The unloaded tray on the unload area can be retrieved by an operator at a later time without interrupting the handler system's operation.

Although the present invention will be described in the context of a handler system with a stacker assembly and trays, such as Seiko Epson Model NS-5000 pick-and-place handler, one of ordinary skill in the art will appreciate that the principles described herein could apply to many types of material handling and assembly systems, and the replacement apparatus could be utilized effectively with holding units other than trays. Such use would be within the spirit and scope of the present invention.

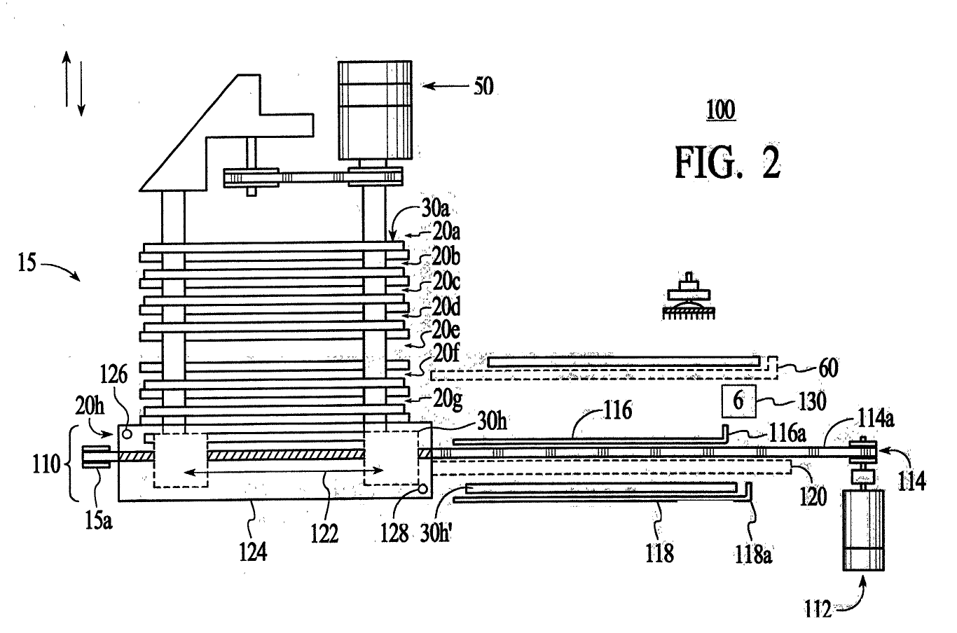

FIG. 2 illustrates a side view of the handler system 100 incorporating the tray replacement apparatus 110 in accordance with an embodiment of the present invention. Features similar in handler system 10 are denoted by similar numbers. The tray replacement apparatus (“TRA”) 110 is integrated internally into the handler system 100 and mounted within the system's 100 metal housing (not shown). The TRA 110 is preferably mounted beneath the output platform 60, as shown in FIG. 2.

The TRA 110 includes a driving system comprising a DC motor 112 connected to a belt and pulley arrangement 114. An unload area 116 and load area 118 are stationary platforms with respective front ends 116a and 118a, the platforms being oriented in such a manner as to face the stacker assembly 15 and its slots 20a-20h. The TRA 110 also includes a linear bearing track 120 which runs alongside the stacker assembly 15, from a back end of the slots 15a to the front ends 116a, 118a of the unload and load platforms, respectively. A housing bracket 124 moves along the linear bearing track 120 via linear bearing blocks 122 which are mounted onto the housing bracket 124 and straddle the linear bearing track 120. A pair of miniature cylinders, an upper cylinder126 and a lower cylinder128, are mounted on a surface of the housing bracket 124 facing the tray 30h.

As is shown, the belt and pulley arrangement 114 runs parallel to the linear bearing track 120. The linear bearing blocks 122 are in physical contact with the belt 114a. Thus, the linear bearing blocks 122, and therefore the housing bracket 124, move along the linear bearing track 120 when the belt 114a to moves longitudinally, which occurs when the DC motor 112 rotates. If the DC motor 112 rotates in a counter clockwise fashion, the belt 114a will move from left to right, thereby causing the housing bracket 124 to move from left to right. The opposite occurs, i.e., the housing bracket 124 moves from left to right, when the DC motor 112 rotates in a clockwise fashion.

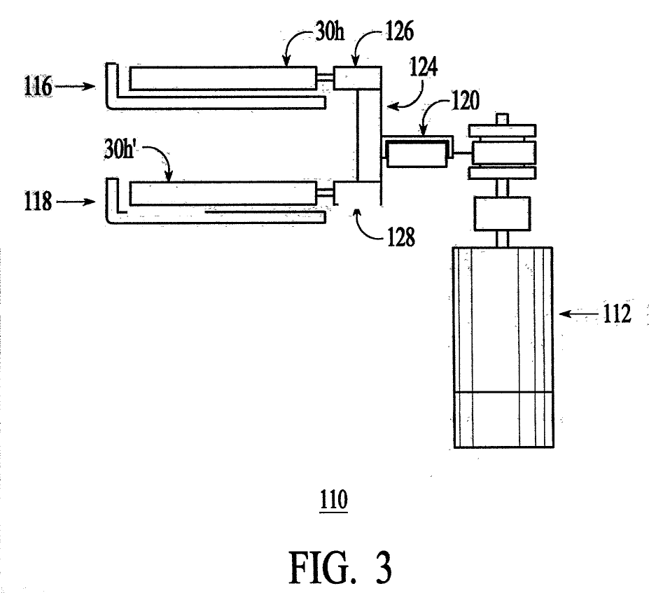

Referring now to FIG. 3, illustrated is a back view of the TRA 110 looking down the linear bearing track 120 from the slots' back end 15a to the fronts of the platforms 116a, 118a. As is seen, TRA 110 is situated such that the upper and lower cylinders 126, 128 are aligned with a tray 30h in the unload area 116 and a tray 30 h′ in the load area 118, respectively. An important feature of the cylinders 126, 128 is the ability to extend and retract.

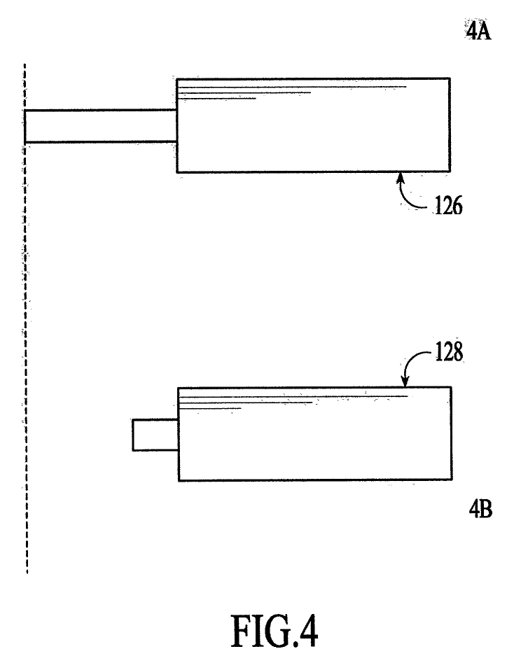

FIG. 4 illustrates this feature which allows the TRA 110 to move a tray 30h to the unload area 116 and a tray 30 h′ from the load area 118. The upper cylinder 126 is shown in FIGS. 4A and 4B. The upper cylinder 126 extends when activated in FIG. 4A, and retracts when deactivated in FIG. 4B. The lower cylinder 128 (not shown) exhibits the same functionality. This feature can be implemented by an electrical solenoid air valve (not shown) connected in parallel to the DC motor 112, as is understood by one skilled in the art. In operation, the upper cylinder 126 is preferably located near the upper back corner of the housing bracket 124 (see FIG. 2), while the lower cylinder 128 is preferably located near the bottom front corner of the housing bracket 124.

When the housing bracket 124 is in a first position to unload the tray 30h from its slot 20h, the upper cylinder 126 is behind the tray 30h, as shown in FIG. 2. When the housing bracket 124 is in the first position, the upper cylinder 126 is activated so that the cylinder 126 engages the tray 30h. Thus, the housing bracket 124 can unload the tray 30h out of its slot 20h via the extended upper cylinder 126.

When the housing bracket 124 is in a second position to load a replacement tray 30 h′ into its slot 20h, the lower cylinder 128 is in front of the replacement tray 30h′. When the housing bracket 124 is in the second position, the lower cylinder 128 is activated so that the lower cylinder 128 engages the replacement tray 30h′. Thus, the housing bracket 124 can load the replacement tray 30 h′ into its slot 20h via the extended lower cylinder 128.

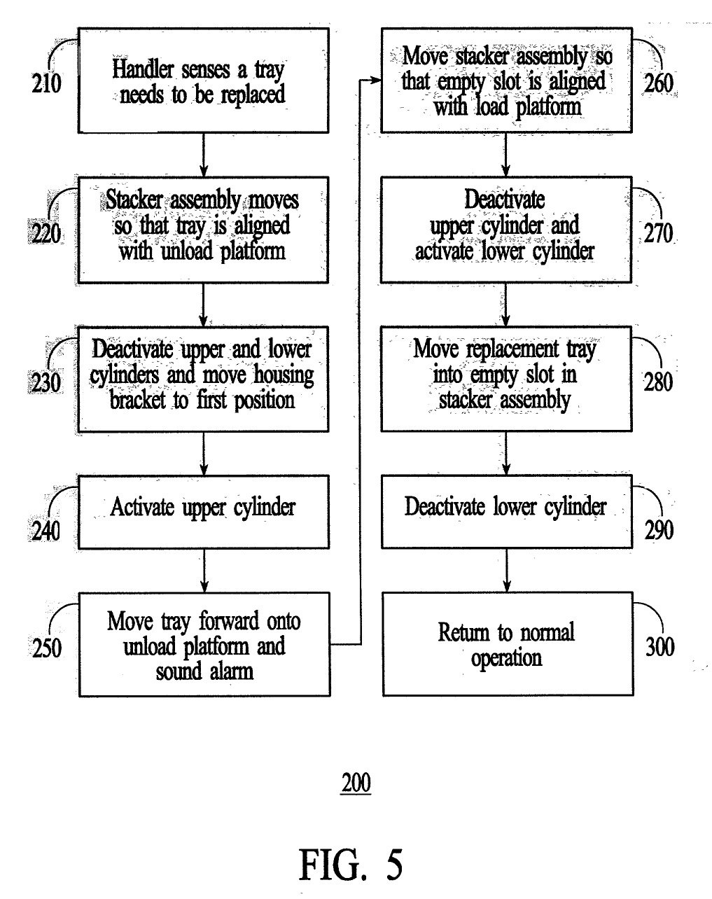

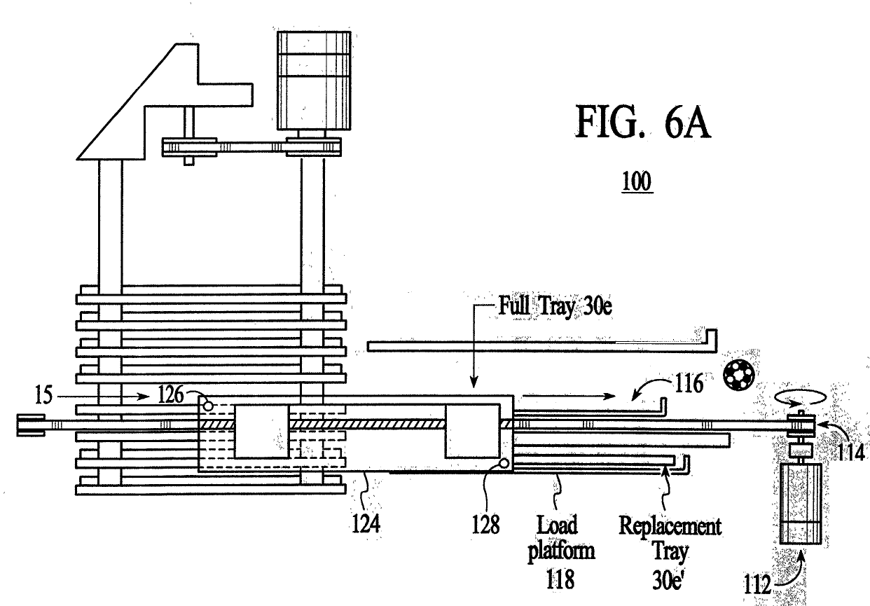

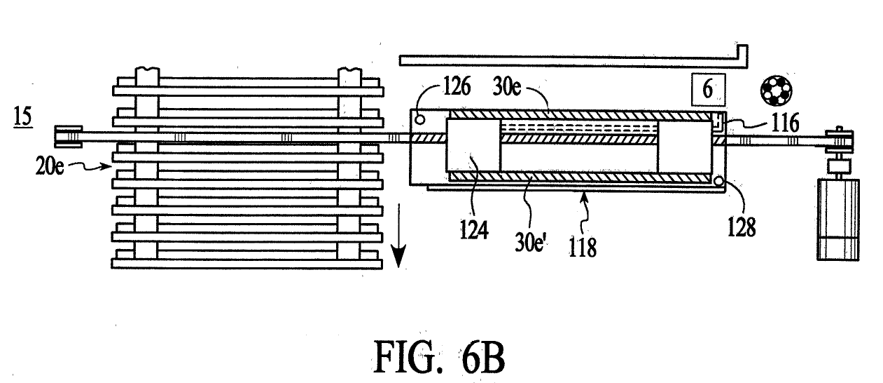

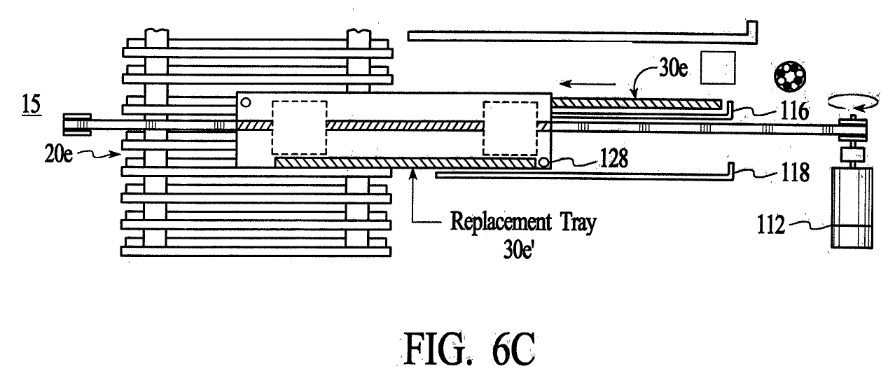

FIGS. 5 and 6 illustrate the tray replacement process in accordance with one embodiment of the present invention. The process 200 illustrated in FIG. 5 starts at step 210 when the handler system 100 senses that a tray 30 needs to be replaced, e.g., the tray 30 is full. In FIG. 6A, tray 30e is full and in need of replacement. The handler system 100 directs the stacker assembly 15 to move so that the tray 30e is aligned with the unload area 116, via step 220. Once aligned, in step 230, the handler system 100 ensures that the upper and lower cylinders 126, 128 are deactivated, and then moves the housing bracket 124 to the first position alongside the tray 30e via the DC motor 112 and belt and pulley arrangement 114.

Next, the upper cylinder 126 is activated such that it extends behind the tray 30e, via step 240. The DC motor 112 then moves the tray 30e forward, via the housing bracket 124 and upper cylinder 126, onto the unload area 116, and an alarm is sounded to alert the operator to remove the tray 30e, in step 250. FIGS. 6A and 6B illustrate how the TRA 110 moves the tray 30e from the stacker assembly 15 to the unload area 116.

As is seen in FIG. 6B, the housing bracket 124 is in the second position when the tray 30e is completely on the unload area 116. Referring back to FIG. 5, in step 260, the stacker assembly 15 moves to align the now empty slot 20e with the load area 118, which holds a replacement tray 30e′. The upper cylinder 126 is deactivated and the lower cylinder 128 is activated such that it extends in front of the replacement tray 30e′, via step 270. Next, in step 280, the DC motor moves the housing bracket 124 to the first position, thereby moving the replacement tray 30e′ from the load area 118 into the slot 20e in the stacker assembly 15. FIG. 6C illustrates this step. Once the replacement tray 30e′ is in place, the lower cylinder 128 is deactivated in step 290, and the handler system 110 returns to normal operation, via step 300.

As stated above, each tray 30a-30h is dedicated to a sort/bin category of the device 40. Thus, when a tray 30 requires replacement, e.g. it becomes full, the handler system 100 of the present invention must inform the operator as to which sort/bin category the tray 30 belongs. One embodiment of the present invention accomplishes this by utilizing a display 130 (FIG. 2) linked to the TRA 110 which indicates the last bin/sort category before the handler system 100 sensed the need for tray replacement. The display 130 can be a multi-segment LED, or any other appropriate display such as an output on a computer screen. In this embodiment, it is assumed that the last device 40 placed in the tray 30 triggers the tray replacement process 200.

So for example, a device 40 is tested, the testing system informs the handler system 100 of the sort/bin category, the handler system 100 aligns the tray 30 corresponding to the device's sort/bin category with, and moves it onto, the output platform 60, where the device 40 is placed in the tray 30. If the tray 30 becomes full, the handler system 100 will begin the tray replacement process 200. The sort/bin category of the device 40, which was the last device 40 to be loaded, is transferred to the display 130. Hence, when the operator comes shortly thereafter to remove the tray 30, the operator will know to what sort/bin category the tray 30 belongs. Once the tray 30 is removed, the display 130 resets and the alarm mutes.

With the handler system 100 in accordance with the present invention, the task of replacing trays 30 is transformed from a manual operation to a semi-automatic task. Thus, operator intervention is minimal, and more importantly, because the handler system 100 resumes operation automatically after replacing the tray 30, system down time is minimized. The operator is only required to remove the tray 30 from the unload area 116, and replenish the load area 118 with another replacement tray 30'. Accordingly, the present invention improves throughput, productivity, and system efficiency, while decreasing manufacturing costs and wasted time.

Although the present invention has been described in accordance with the embodiments shown, one of ordinary skill in the art will readily recognize that there could be variations to the embodiments and those variations would be within the spirit and scope of the present invention. Accordingly, many modifications may be made by one or ordinary skill in the art without departing from the spirit and scope of the appended claims.

What is claimed is:

1. An automated handler system comprising:
a plurality of trays, each tray of the plurality of trays holding at least one device;
a stacker assembly housing the plurality of trays; and
a tray replacement apparatus mounted in the handler system for automatically replacing a tray in the stacker assembly with a replacement tray.

2. The system of claim 1, wherein the tray replacement apparatus further includes an unload area and a load area, the load area housing the replacement tray.

3. The system of claim 2, wherein the tray replacement apparatus further includes a housing bracket and a driving element, wherein the driving element moves the housing bracket laterally along a track disposed adjacent to the stacker assembly and adjacent to the unload and load areas.

4. The system of claim 3, wherein the housing bracket further comprises at least one cylinder, the at least one cylinder being mounted on the housing bracket and used for moving the tray housed in the stack assembly and the replacement tray.

5. The system of claim 4, wherein a first cylinder is activated so that the housing bracket is capable of pushing the tray out of the stack assembly and onto the unload area, and wherein a second cylinder is activated so that the housing bracket is capable of pushing the replacement tray out of the load area.

6. The system of claim 3, wherein the stacker assembly is connected to a servomotor for moving the stack assembly.

7. The system of claim 6, wherein the servomotor moves the stacker assembly so that a tray in need of replacement is aligned with the unload area.

8. The system of claim 7, wherein the housing bracket moves the tray from the stacker assembly onto the unload area, thereby creating a vacancy in the stacker assembly; the servomotor moves the stacker assembly such that the vacancy is aligned with the load area; and the housing bracket moves the replacement tray from the load area into the vacancy.

9. The system of claim 8, wherein the handler system resumes normal operations.

10. The system of claim 8, wherein an alarm sounds when the tray is moved from the stacker assembly onto the unload area.

11. The system of claim 3, wherein the driving element comprises a DC motor coupled to a belt and pulley assembly connected to the housing bracket.

12. The system of claim 1, wherein each tray is associated with a sort/bin category, and the tray replacement apparatus further includes a sort/bin category display that displays the sort/bin category of a tray in need of replacement to an operator.

13. The system of claim 1, wherein the automated handler system is a Sieko Epson model NS-5000.

14. An automated handler system for integrated devices comprising:
a plurality of trays, each tray of the plurality of trays holding at least one device;
a stacker assembly housing the plurality of trays; and
a tray replacement apparatus mounted in the handler system for automatically replacing a tray in the stacker assembly with a replacement tray, the tray replacement apparatus further including:
an unload area;
a load area; the load area housing the replacement tray;
a housing bracket; and
a driving element for moving the housing bracket along a track disposed adjacent to the stacker assembly and adjacent to the unload and load areas.

15. The system of claim 14, wherein the stacker assembly is connected to a servomotor, the servomotor moving the stacker assembly so that a tray in need of replacement is aligned with the unload area.

16. The system of claim 15, wherein the housing bracket moves the tray from the stacker assembly onto the unload area, thereby creating a vacancy in the stacker assembly; the servomotor moves the stacker assembly such that the vacancy is aligned with the load area; and the housing bracket moves the replacement tray from the load area into the vacancy.

17. The system of claim 14, wherein each tray is associated with a sort/bin category, and the tray replacement apparatus further includes a sort/bin category display that displays the sort/bin category of a tray in need of replacement to an operator.

18. The system of claim 14, wherein the housing bracket further comprises at least one cylinder, and wherein a first cylinder is activated so that the housing bracket is capable of pushing the tray out of the stack assembly and onto the unload area, and wherein a second cylinder is activated so that the housing bracket is capable of pushing the replacement tray out of the load area.

19. A system for automatically replacing a device holder in a holding assembly comprising:
an unload area for receiving the device holder;
a load area, the load area housing a replacement device holder;
a housing bracket; and
a driving element for moving the housing bracket along a track disposed adjacent to the holding assembly and adjacent to the unload and load areas.

20. The system of claim 19, wherein the housing bracket moves the device holder from the holder assembly onto the unload area, thereby creating a vacancy in the holder assembly; and wherein the housing bracket moves the replacement tray from the load area into the vacancy.

21. The system of claim 19, wherein the housing bracket further comprises at least one cylinder, and wherein a first cylinder is activated so that the housing bracket is capable of pushing the device holder out of the holder assembly and onto the unload area, and wherein a second cylinder is activated so that the housing bracket is capable of pushing the replacement holder out of the load area.

22. The system of claim 19, wherein the driving element comprises a DC motor coupled to a belt and pulley assembly connected to the housing bracket.

23. A method for automatically replacing a tray in a handler system, the tray holding at least one device, the method comprising the steps of:
a) providing a stacker assembly housing a plurality of trays;
b) providing a tray replacement apparatus mounted in the handler system;
c) identifying a tray in need of replacement;
d) adjusting the stacker assembly such that the tray in need of replacement is aligned with the tray replacement apparatus;
e) replacing the tray with a replacement tray utilizing the tray replacement apparatus.

24. The method of claim 23, wherein the tray replacement apparatus includes an unload area and a load area, the load area housing the replacement tray.

25. The method of claim 24, wherein the adjusting step (d) further includes the step of moving the stacker assembly so that the tray in need of replacement is aligned with the unload area.

26. The method of claim 25, wherein the tray replacement apparatus further comprises a housing bracket and a driving element, wherein the driving element moves the housing bracket laterally along a track disposed adjacent to the tray in need of replacement and adjacent to the unload and load areas.

27. The method of claim 26, wherein the replacing step (e) further comprises the steps of:
e1) utilizing the housing bracket to move the tray from the stacker assembly onto the unload area, thereby creating a vacancy in the stacker assembly;
e2) moving the stacker assembly such that the vacancy is aligned with the load area; and
e3) utilizing the housing bracket to move the replacement tray from the load area into the vacancy.

28. The method of claim 27 further comprising the steps of:
f) resuming normal operation of the handler system;
g) removing the tray from the unload area; and
h) replenishing the load area with another replacement tray.

29. The method of claim 28, wherein the housing bracket further comprises at least one cylinder, the at least one cylinder being mounted on the housing bracket and used for moving the tray and the replacement tray.

30. The method of claim 29, wherein the utilizing step (e1) further includes the steps of:
(e1a) activating a first cylinder so that the housing bracket is capable of pushing the tray out of the slot and into the unload area; and
(e1b) sounding an alarm to alert an operator to remove the tray from the unload area.

31. The method of claim 30, wherein the utilizing step (e3) further includes:
(e3a) activating a second cylinder so that the housing bracket is capable of pushing the replacement tray out of the load area and into the slot.

32. The method of claim 31 further comprising the steps of:
(i) deactivating the first and second cylinders; and
(j) muting the alarm.

33. The method of claim 26, wherein the driving element includes a DC motor coupled to a belt and pulley assembly, and wherein the belt is connected to the housing bracket.

34. The method of claim 23, wherein the handler system is a Seiko Epson model NS-5000.

35. The method of claim 32, wherein each tray of the plurality of trays is associated with a sort/bin category, and the identifying step (c) further comprises the step of:
c1) identifying a sort/bin category associated with the tray in need of replacement;
c2) transferring the sort/bin category to a display coupled to the tray replacement apparatus; and
c3) displaying the sort/bin category of the tray in need of replacement to an operator.

36. The method of claim 35 further comprising the step of:
(k) resetting the display.
